(19) United States
(12) Patent Application Publication
(10) Pub. No.: US 2010/0043743 A1
(43) Pub. Date: Feb. 25, 2010

(54) DUAL STROKE COMBUSTION/STEAM ENGINE

(76) Inventor: James F. Maxwell, Provo, UT (US)

Correspondence Address: JAMES SONNTAG;JAMES SONNTAG, PATENT ATTORNEY, P.O. BOX 9194, SALT LAKE CITY, UT, 84109, US

(21) Appl. No.: 12/557,686

(22) Filed: Sep. 11, 2009

Related U.S. Application Data
(63) Continuation of application No. PCT/US2008/056557, filed on Mar. 11, 2008.
(60) Provisional application No. 60/894,291, filed on Mar. 12, 2007.

(51) Int. Cl. F02B 47/02

(52) U.S. Cl. 123/25 C

(57) ABSTRACT

A thermally efficient engine incorporating an internal combustion cycle and a steam cycle in a dual stroke cylinder where combustion moves pistons in one direction and steam moves the same pistons in the return direction. The steam cycle recovers heat from the combustion cycle, and provides cooling of the cylinder. Heat from the combustion gasses is used to preheat pressurized feed water to a high temperature for the steam cycle.

### CROSS REFERENCE TO RELATED APPLICATIONS

This is a continuation from International Application under the Patent Cooperation Treaty Number PCT/US2008/056557, International Filing Date 11 Mar. 2008, which claims priority from U.S. Provisional Patent Application 60/894,291, filed 12 Mar. 2007, all of which are hereby incorporated by reference.

### BACKGROUND OF INVENTION

A number of engines have been developed with the objective to increase engine efficiency by using internal cooling by injecting water in a separate cycle to obtain steam power in addition to power from burning fuel.

### SUMMARY OF INVENTION

An aspect of the present invention is an engine powered by both a combustion cycle and a steam cycle, and is operated at a high operating temperature. It has increased thermal efficiency for more mechanical energy derived from the steam. For example, with an operating temperature at or below 360 degrees Fahrenheit, little power is realized from the steam because of the low steam pressure. However, with an operating temperature of 700 degrees Fahrenheit, pressure of saturated steam is above 3000 psi, which is higher than the pressure from the combustion of engine fuel. With the mechanical energy from the combustion combined with the mechanical energy from high pressure and temperature steam, greater power is realized. With feed water being superheated by combustion exhaust gasses, a substantial quantity of water can be metered into the engine for each cycle, thus producing a larger amount of power from steam. Overheating of the engine is controlled by refrigeration effect of the expanding steam in the cylinder.

A dual stroke internal combustion steam powered engine has a combustion cycle and a steam cycle. The engine comprises one or a plurality of engine cylinders, each with a first combustion end and a second steam end, a combustion head at the first end and a steam head at the second end. A piston reciprocally operates between the first and second ends. A piston rod is attached to the piston and extending through the steam head. The engine cylinder and combustion head are constructed to provide a combustion cycle that moves the piston away from the first end. The combustion cycle occurs in a combustion chamber, which is a region in the engine cylinder between the piston and the first end. The engine cylinder and steam head are constructed to provide a steam cycle that moves the piston away from the second end, the steam cycle occurring in a steam chamber, which is a region in the engine cylinder between the piston and the second end. The combustion chamber and the steam chamber are both in the engine cylinder and alternately use a common region in the combustion cylinder as the piston operates between the first and second ends.

### BRIEF DESCRIPTION OF DRAWINGS

FIG. 1 is a schematic of an exemplary engine.

FIG. 2 is a schematic of another exemplary engine.

### DETAILED DESCRIPTION

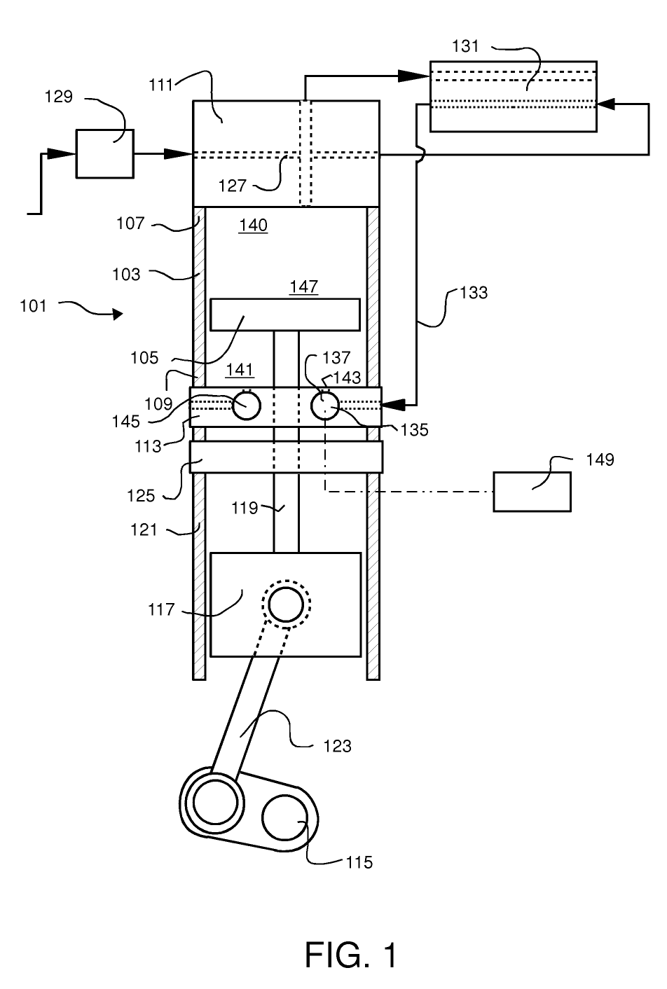

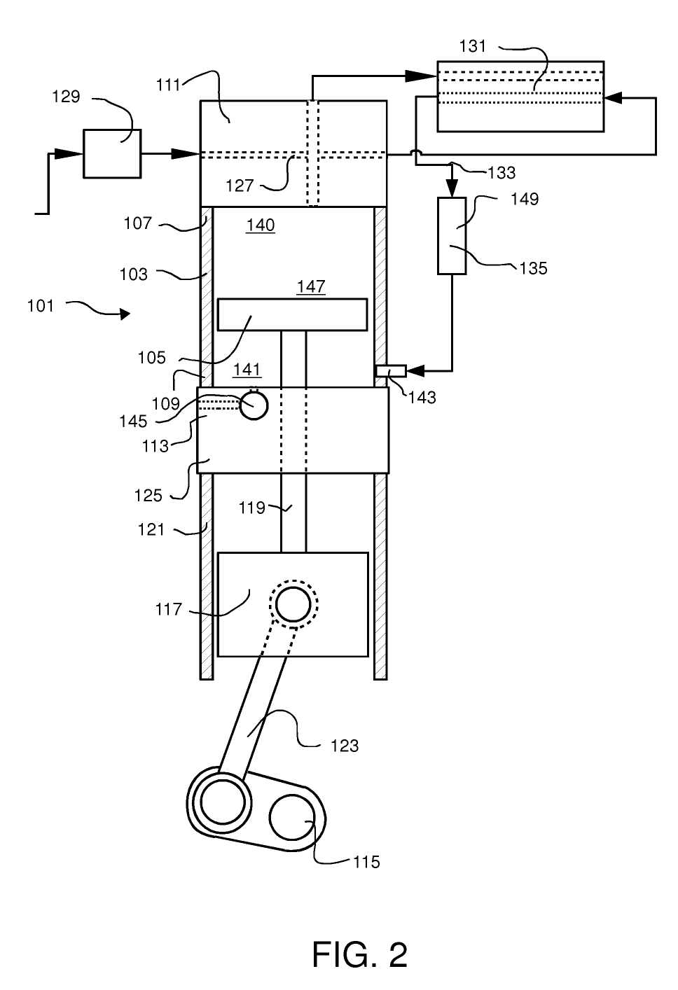

Reference is made to FIG. 1 and FIG. 2, which are schematics of exemplary engines. The engine 101 comprises a dual action cylinder 103 (shown in cross-section) with a piston 105 operating reciprocally in the cylinder. The piston operates in a first end 107 of the cylinder 103 as a combustion engine and in a second end 109 the piston operates as a steam engine. The engine cylinder 103 is enclosed by a combustion head 111 at the first end and a steam head 113 at the second end.

The combustion cycle occurs in a combustion chamber 140 between the piston and the combustion head 111. The combustion head 111 includes structure that may include valves or injectors, and other structure to provide a suitable combustion cycle. The power stroke of the combustion cycle forces the piston toward the second end, and the power stroke of the steam cycle forces the piston toward the first end.

The steam cycle occurs in a steam chamber 141 between the piston and the steam head 113. The steam head 113 contains suitable structure to provide a steam cycle. For example, the steam head may include a water inlet 143 (shown as a rotary valve in FIG. 1), and steam exhaust valve 145 (shown as a rotary valve or other suitable valve in FIGS. 1 and 2)

As the piston 105 reciprocally operates in the engine cylinder 103 both the combustion cycle and the steam cycle occur in the cylinder and alternately use a same common region 147 in the cylinder, with the combustion chamber and the steam chamber changing with the movement of the piston.

In applications where the output is rotary motion, the piston 105 is operably attached to a crankshaft 115 to convert the reciprocal motion of the piston to rotary motion. A piston rod 119 extends from the piston and passes through the steam head 113 to a cross head 117 between the crankshaft and the piston. The function of the cross-head is to make the piston rod in the cylinder run parallel to the cylinder walls as the piston rod operates between the piston and cross head. This allows a seal where the rod passes through the steam head.

Heat for the steam portion of the engine is obtained from combustion exhaust gasses from the combustion, cylinder walls, and combustion cylinder head using a heat exchange system. An exemplary heat exchange system includes pump 129 for pumping water under pressure through water passages 127 in the cylinder combustion head 111, thence to a counter flow heat exchanger 131 to transfer heat from the combustion exhaust gas to the water. A suitable construction may comprise, for example, a system where the combustion exhaust gasses move past an outlet end of water tubes and where the exhaust gasses travel in a circular or back and forth pattern past the water tubes.

The water is then conveyed by line 133 to metering equipment 135 to introduce heated water or steam into the steam chamber or steam engine portion 141 of the engine cylinder. The metering equipment may include a rotary valve 137 as illustrated in FIG. 1, or any other system that suitably meters water into the steam engine portion, including a separate metering system as in FIG. 2.

The water may optionally be pumped at a pressure greater than the vapor pressure of the heated water to maintain the water in a liquid form until it enters the cylinder, which is above operating pressure or the vapor pressure of water at the operating temperature. Once in the cylinder the liquid water flashes and expands into steam. Steam may also be metered into the cylinder, but at a pressure sufficiently close to the vapor pressure to allow a significant expansion in the cylinder. The cylinder walls and pistons that were previously heated in the cycle from combustion are cooled by the refrigeration effect of expanding steam, while at the same time heating the steam, which prevents water condensation, increases power from steam expansion and improves engine efficiency. Feed water is preheated In order to achieve the high steam pressure in the cylinder to increase power, and prevent excessive water condensation in the cylinder. The temperature depends on factors involving construction and operation, but temperatures high enough to obtain high-steam pressures, above about 500 degrees F. should be suitable. At these high pressures the steam cycle can contribute significant power to the engine, and recover as useful mechanical energy a significant amount of the heat energy produced by the combustion cycle. Lower temperatures under 500 degrees F. may be suitable in certain applications.

A valve control system is used to control and synchronize valves in the combustion and steam heads, and meter the water. The timing is such and the cylinder and piston is constructed to effect a dual stroke cycle with a combustion cycle and a steam cycle as the piston reciprocates in the cylinder. The steam cycle may provide a power stroke for every turn of the crankshaft (2 cycle) or any other suitable power stroke interval (e.g., 4, 6, or 8 cycle). Structure may be provided to selectively change the power stroke interval to respond to the power requirements of the engine.

The combustion cycle used can be a diesel cycle, an ignition cycle, or any other suitable 2- or 4 stroke cycle where fuel is combusted.

A thermostatic control system 149 may be used with a metering system 135, or a valve control system to control the quantity of water or steam passed into the second end based upon the temperature of the water in the heat exchanger, with the amount of water metered into the engine being reduced as the temperature of the water lowers.

Because of the high operating temperature of the cylinder, construction and materials to accommodate high temperatures and pressures may be optionally used. Optionally, the cylinder is at least in part thermally isolated from the crankshaft to control the temperature at the crankshaft at a temperature below the operating temperature of the cylinder. This may be desirable to maintain a crankshaft temperature for lower material costs and to eliminate special measures for lubrication. Thermal isolation can be provided by, for example, having the cylinder assembly separate, or insulated from a block that includes the crankshaft. The thermal insulation may not be required, or can be provided by any other suitable system.

An optional variation of the engine involves the addition of an air compressor to compress the air passed into the combustion cycle. The compressor operates directly off of the crankshaft, piston rod, or any other suitable power source. Turbochargers may not be optimal because they reduce the heat in the exhaust available for heating the feed water. Referring to FIGS. 1 and 2, an exemplary compressor includes a cross-head 117 constructed to function as a second piston in a compression cylinder 121 closer to the crankshaft with a conventional connecting rod 123 attached between the cross head and the crankshaft. With this construction, the cross-head/piston 117 can be used to compress air by using a compressor head 125 to enclose the compression cylinder 121 chamber. The compressor head 125 with suitable valving is placed at an end of the compression cylinder (e.g., between the steam head and the cross head, or as part of the steam head) to provide a compressor function. In order to thermally isolate the compressor head from the heat of water being injected into the steam chamber 141, the compressor head may be separated from the steam head where the water is injected through a water inlet 143 in the steam head. Referring to FIG. 1, in order to prevent the hot entering water from overheating the compressor head and underlying crankshaft assemblies, a thermal break or insulation may be placed under the steam head. Alternately the water inlet 143 for the metered water can be separated from the steam head. In this construction, the steam head and the compressor head can be built together as a unit. As illustrated in FIG. 2, the compressor head and the steam head can be incorporated together with a remote heated water metering device.

If the cross-head is not used as a compression piston, its construction may be or not be in the form a piston, but be any suitable cross-head construction, as for example, a casting sliding in cross-head guides or rails.

Reference has been made to a “cylinder” but it is understood that an engine can have one cylinder or multiple cylinders, each with the dual stroke steam/combustion cycle.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A dual stroke internal combustion steam powered engine having a combustion cycle and a steam cycle comprising;
engine cylinder with a first combustion end and a second steam end, a combustion head at the first end and a steam head at the second end;
piston that reciprocally operates between the first and second ends;
piston rod attached to the piston and extending through the steam head; the engine cylinder and combustion head constructed to provide a combustion cycle that moves the piston away from the first end, the combustion cycle occurring in a combustion chamber, which is a region in the engine cylinder between the piston and the first end, and
the engine cylinder and steam head constructed to provide a steam cycle that moves the piston away from the second end, the steam cycle occurring in a steam chamber, which is a region in the engine cylinder between the piston and the second end;
where the combustion chamber and the steam chamber are both in the engine cylinder and alternately use a common region in the combustion cylinder as the piston operates between the first and second ends.

2. The engine of claim 1 additionally comprising heat transfer structure for transferring heat from combustion gasses from the combustion cycle to water injected into the engine cylinder for the steam cycle.

3. The engine of claim 2 wherein the heat transfer structure heats the water sufficiently to suppress steam condensation in the cylinder.

4. The engine of claim 3 wherein the water is injected as a liquid under pressure and the water changes to steam in the engine cylinder.

5. The engine of claim 4 wherein the heat exchange structure comprises one or more of a counter-current heat exchanger and one or more water passages in the combustion head.

6. The engine of claim 4 wherein the heat exchange structure is constructed to heat the pressurized water above 500 degrees F.

7. The engine of claim 1 wherein the steam cycle is a 2 stroke cycle.

8. The engine of claim 1 wherein the stroke cycle of the steam cycle is 4 or more.

9. The engine of claim 1 wherein the piston rod is operably connected to the crankshaft to convert motion of the piston rod to rotary motion.

10. The engine of claim 9 additionally comprising a cross-head,
wherein the piston rod extends between the piston and the cross-head, the cross-head constructed to maintain the motion of the piston rod parallel to walls of the cylinder, and
wherein the cross-head is connected to the crankshaft by a connecting rod.

11. The engine of claim 10 additionally comprising an air compressor.

12. The engine of claim 11 additionally comprising a compression cylinder with a compression head at one end, and wherein the cross-head is constructed and configured to function as a piston in the compression cylinder as it reciprocates in the compression cylinder, the cross-head, compression cylinder and compression head function as the air compressor.

13. The engine of claim 12 wherein air from the air compressor is used for the combustion cycle.

14. The engine of claim 2 additionally comprising a thermostatic control system that controls the quantity of liquid water or steam introduced into the steam cylinder based on the temperature of water in the heat exchange structure and demand for power.

15. The engine of claim 1 wherein there are at least two engine cylinders.
